(19) United States
(12) Patent Application Publication
(10) Pub. No.: US 2025/0144683 A1
(43) Pub. Date: May 8, 2025

(54) DECONTAMINATION OF SOIL

(71) Applicant: MTT RECYCLING TECHNOLOGIES LTD., Kfar Qasim (IL)

(72) Inventor: Ariel ROSENBERG, Moshav Bnei Zion (IL)

(21) Appl. No.: 18/836,941

(22) PCT Filed: Feb. 9, 2023
(86) PCT No.: PCT/IL2023/050140

§ 371 Date: Aug. 8, 2024

Related U.S. Application Data
(60) Provisional application No. 63/308,504, filed on Feb. 10, 2022.

(30) Foreign Application Priority Data
Nov. 28, 2022 (IL) 298650

(51) Int. Cl. B09C 1/06

(52) U.S. Cl. CPC B09C 1/06

(57) ABSTRACT

The present invention relates to systems of decontamination of solids from hydrocarbon compounds and recovery of the hydrocarbon compounds, the systems comprise at least one hydrocarbon removal unit, wherein the hydrocarbon compounds optionally comprise petroleum hydrocarbons. The systems convey a reflux stream consisting of a portion of condensed hydrocarbon vapors which is used to wash the contaminated solids and to produce recovered condensed hydrocarbon vapors.

### FIELD OF THE INVENTION

The present invention relates to systems of decontamination of solids from hydrocarbon compounds and recovery of the hydrocarbon compounds, the systems comprise at least one thermal hydrocarbon removal unit, wherein the hydrocarbon compounds optionally comprise petroleum hydrocarbons. The systems convey a reflux stream consisting of a portion of condensed hydrocarbon vapors which is used to wash the contaminated solids and to produce recovered condensed hydrocarbon vapors.

### BACKGROUND OF THE INVENTION

Polluting hydrocarbon compounds and contamination of soil or small solid particles is an ever-growing problem which may cause negative environmental effects, and therefore requires the immediate concern of governments and private agencies alike.

Polluting hydrocarbon compounds typically comprise petroleum hydrocarbons (PHC), such as crude oil, gasoline, kerosine, diesel, industrial fuel oil, lubricating oil, other petrochemicals, and the like. Petroleum hydrocarbons can originate from various fields (mining, transportation, filtering, etc.) and include flotation chemicals (such as from mineral processing), sludge (such as from filters, refineries tanks, marine transportation, etc.), contaminated earth soil from industrial sites, oil spill (sea and ground), industrial catalysts, and the like. These petroleum hydrocarbon compounds can permeate or penetrate into the earth ground, resulting in the contamination thereof, and the possible contamination of underground water sources, thus making them undrinkable or unsuitable for human and/or animal consumption.

Contamination with light hydrocarbon compounds having low vapor pressure, are of a lesser problem since these compounds evaporate at room temperature. However, the decontamination of heavier hydrocarbon compounds presents a complicated challenge. Furthermore, the incorporation of heavy metal residues within the soil is problematic, since these residues may penetrate into the ground even if the hydrocarbon compounds are removed.

Some of the known devices and systems for recovering hydrocarbon compounds from solid particles (such as contaminated soil) include direct and indirect thermal desorption or thermal conduction heating (TCH) techniques, in which the contaminated soil enters either into a none sealed chamber in which the hydrocarbons are incinerated, or into a heated sealed chamber, in which the hydrocarbon compounds are vaporized from the soil by thermal conduction, and are typically condensed further on, thus obtaining decontaminated soil particles and recovered and condensed hydrocarbon vapors.

For example, U.S. Pat. No. 5,242,245 discloses a method and apparatus for recovering hydrocarbons from soils which includes introducing the soil material to be treated through a vacuum seal and into a thermal processor which is operated under reduced pressure. The processor includes a centralized heating unit surrounded by concentrically mounted rotatable cylinders. One of the cylinders has a continuous auger extending from the surface thereof and proximate to the other cylinder by way of which the material is conveyed through the processor with a relative of rotation of the cylinders being controlled to ensure optimum vapor separation of the hydrocarbons at low temperature after which the vapors are recovered and condensed.

U.S. Pat. No. 5,656,178 discloses a method for the treatment of contaminated materials such as impounded sludges and contaminated soils by thermal desorption wherein a solid matrix is subjected to the action of superheated steam in a closed vessel, a gas stream comprising superheated steam is recirculated to the vessel and recirculation of the superheated steam is continued until organic constituents are separated therefrom to predetermined concentrations that are environmentally insignificant and within the limits prescribed by governmental regulations.

U.S. Pat. No. 7,294,173 discloses a method for desorption and recovery of desorbed compounds, including the steps of generating a recirculating stream of inert gas (1), which passes through the material (2) to be desorbed, heating such inert gas stream to a temperature sufficient to cause the desorption process, yielding a gas effluent (3) from such recirculating stream of inert gas (1) in such a manner that the recirculated gas keeps a constant pressure, cooling such gas effluent to cause condensation of the desorbed compounds contained in such gas effluent (3), the cooling being obtained at least partly by pressure vaporization of a cryogenic fluid (4), and feeding such recirculating gas stream (1) by using at least a part of such pressure vaporized cryogenic fluid that was previously used to cool at least a part of the gas effluent (3).

The existing thermal techniques and systems have some disadvantages, such as their inability to perform effective decontamination of heavier hydrocarbon compounds from soil, due to the high temperatures required for the evaporation thereof and their tendency to condense and clog portions of the systems. One cause of the system clogging is the formation of petroleum coke during the high temperature evaporation in the presence of oxygen (either entering from the surroundings when the system is not sealed, or released from porous materials found therein). Furthermore, the existing thermal techniques typically includes emissions of polluting particles which are incorporated in the hydrocarbon vapors.

Thus, there is an ongoing need to provide systems and methods for decontamination of solids from hydrocarbon compounds, which are efficient, cost effective and environmentally friendly.

### SUMMARY OF THE INVENTION

The present invention provides systems and methods for decontaminating solids (i.e., soil, particles, granules,) from hydrocarbon compounds and recovering at least a portion of the hydrocarbon compounds, specifically by use of thermal hydrocarbon removal systems or devices.

Thus, according to a certain aspect, there is provided a system for decontaminating contaminated solids from hydrocarbon compounds, the system comprising at least one thermal hydrocarbon removal unit, which extends from a first edge to a second edge. The thermal hydrocarbon removal unit comprises an elongated inner tube, which defines an inner space therein. The inner tube comprises a solids inlet opening proximal to the first edge, a solids outlet opening proximal to the second edge, and a vapor outlet opening positioned longitudinally between the first edge and the second edge. The thermal hydrocarbon removal unit further comprises a transportation means, disposed within the inner space of the elongated inner tube, and configured to transport solids in the direction from the first edge towards the second edge of the thermal hydrocarbon removal unit. The system further comprises at least one heating device configured to apply indirect heat to the inner space of the elongated inner tube, and a cooling unit connected to the vapor outlet opening of the inner tube, through an outlet line, wherein the outlet line is oriented so that the cooling unit is positioned above the vapor outlet opening.

According to some embodiments, the at least one thermal hydrocarbon removal unit further comprises an elongated outer tube extending circumferentially around the inner tube and in thermal communication therewith, wherein the at least one heating device is configured to apply heat to the elongated outer tube, to indirectly heat the inner space of the elongated inner tube. According to some embodiments, the at least one thermal hydrocarbon removal unit is in the form of a double tube, which defines an intermediate space between the elongated inner tube and the elongated outer tube. According to some embodiments, the at least one heating device is configured to produce a hot gas and to deliver the hot gas to the intermediate space between the elongated inner tube and the elongated outer tube. According to some embodiments, the at least one heating device comprises a burner, and is coupled to a fuel supply.

According to some embodiments, the at least one thermal hydrocarbon removal unit is inclined, so that the second edge thereof is at a higher position relative to the first edge thereof. According to some embodiments, the at least one thermal hydrocarbon removal unit further comprises a liquid outlet longitudinally positioned between the first edge of the thermal hydrocarbon removal unit and the vapor outlet opening. According to some embodiments, the liquid outlet is connected to a liquid container. According to some embodiments, the at least one thermal hydrocarbon removal unit is inclined, wherein the vapor outlet opening is at a higher position relative to the liquid outlet of the thermal hydrocarbon removal unit, for allowing liquid to gravitationally flow from the vapor outlet opening to the liquid outlet through the inner space of the elongated inner tube. According to some embodiments, the vapor outlet opening is positioned longitudinally between the solids inlet opening and the solids outlet opening.

According to some embodiments, the system further comprises a solid introduction assembly comprising a feed tank connected to the solids inlet opening through a valve, which is configured to regulate an introduction rate of solids into the inner space of the elongated inner tube. According to some embodiments, the valve is a sealing valve configured to restrict air inflow into the inner space of the elongated inner tube.

According to some embodiments, the transportation means comprises a rotating spiral screw coupled to a motor. According to some embodiments, the system further comprises a solid collection assembly comprising a decontaminated solid tank in fluid communication with the solids outlet opening through a valve.

According to some embodiments, the cooling unit comprises a water sprinkler, and is configured to condense hydrocarbon gas to form a liquid/gas mixture and separate it into a gas portion and a liquid portion, wherein the cooling unit further comprises a gas outlet and a liquid outlet, wherein the gas outlet is positioned above the liquid outlet. According to some embodiments, the gas outlet is connected to a gas treatment assembly, comprising a pump and an abatement system; and the liquid outlet is connected to a liquid treatment assembly, comprising a separator configured to separate water from hydrocarbons, wherein the separator further comprises a water outlet and a hydrocarbon outlet, connected to a hydrocarbon container.

According to some embodiments, the outlet line is in the form of a bent tube, and comprises a first section, which extends from the vapor outlet opening towards a line bending, and a second section which extends from the line bending towards the cooling unit, wherein the second section has a diameter which is smaller than a diameter of the first section.

Thus, according to a further aspect, there is provided a system for decontaminating contaminated solids from hydrocarbon compounds, the system comprising: (a) at least one thermal hydrocarbon removal unit comprising transportation means disposed therein, and a solid inlet, a solid outlet, a liquid outlet, and a vapor outlet coupled thereto. The at least one thermal hydrocarbon removal unit is configured to apply indirect heat to the contaminated solids, while said transportation means is configured to convey the contaminated solids therethrough. The indirect heat generates volatile hydrocarbon vapors within the at least one thermal hydrocarbon removal unit.

According to some embodiments, the system further comprises (b) at least one outlet line in solid-fluid communication with the vapor outlet of the thermal hydrocarbon removal unit, wherein said at least one outlet line enables hydrocarbon vapors flow therethrough, and (c) at least one cooling unit in solid-fluid communication with the at least one outlet line, configured to condense a first portion of the hydrocarbon vapors entering thereto. A first fraction of the condensed hydrocarbon vapors is released out therefrom to produce a first hydrocarbon liquid product. A second fraction of the condensed hydrocarbon vapors is recirculated back into the outlet line to form a reflux stream flowing back into the thermal hydrocarbon removal unit. A second portion of the hydrocarbon vapors which does not condense is released as vapors to the external environment.

According to some embodiments, the reflux stream flows downwards within the thermal hydrocarbon removal unit and dissolves at least partially the contamination from the solids conveyed therethrough, thus enabling to produce and release decontaminated solids via the solid outlet of the thermal hydrocarbon removal unit, and to produce a second hydrocarbon liquid product via the liquid outlet thereof.

According to some embodiments, the system further comprises a feed tank or pipe configured to introduce or to convey the contaminated solids into the thermal hydrocarbon removal unit. According to further embodiments, the system further comprises a valve in solid-fluid communication with the feed tank or pipe, configured to regulate a release rate of the solids therethrough and into the at least one thermal hydrocarbon removal unit via the solid inlet. According to some embodiments, the valve is further configured to prevent air inflow into the system and specifically into the thermal hydrocarbon removal unit.

According to some embodiments, the at least one thermal hydrocarbon removal unit is an inclined elongated double tube comprising an inner tube disposed within an outer tube, the contaminated solids are conveyed through an inner space within the inner tube by the transportation means, and the inner tube is in solid-fluid communication with the solid inlet, solid outlet, liquid outlet, and the vapor outlet.

According to some embodiments, a hot gas or heat generated by a heating element is conveyed to an inner space formed between the outer tube and the inner tube, thus enabling to apply indirect heat via the inner tube to the contaminated solids conveyed therethrough.

According to further embodiments, the thermal hydrocarbon removal unit is in fluid communication with a heating device configured to provide the hot gas thereto, wherein said heating device comprises a fuel inlet pipe enabling to receive fuel from a fuel source, thus producing a flame within the heating device.

According to some embodiments, the transportation means comprise a rotating spiral screw or a moving conveyor belt. According to further embodiments, the transportation means comprise a rotating spiral screw (auger) coupled to an actuator, wherein said rotating spiral screw is configured to convey the contaminated solids via rotational movement upwards within the inner space of the inner tube of the inclined elongated double tube.

According to some embodiments, the system further comprises a valve in solid-fluid communication with the solid outlet of the thermal hydrocarbon removal unit configured to regulate the release rate of decontaminated solids therethrough, and optionally wherein the system further comprises a solids tank in fluid communication with the valve to receive and store the decontaminated solids therein. According to some embodiments, the valve is further configured to prevent air inflow into the system and specifically into the thermal hydrocarbon removal unit.

According to some embodiments, the cooling unit is in fluid communication with an oil in water separator, configured to separate water from the first fraction of the condensed hydrocarbon vapors flowing therethrough, thus forming the first hydrocarbon liquid product, and optionally wherein the separator is in fluid communication with a liquid tank configured to receive and store the first hydrocarbon liquid product therein

According to some embodiments, the cooling unit is in fluid communication with an abatement system via a vacuum pump, wherein said abatement system is configured to detoxify the second portion of the hydrocarbon vapors which does not condense flowing therethrough, and wherein the abatement system is in fluid communication with a gas outlet pipe configured to release the detoxified vapors to the external environment therefrom.

According to some embodiments, the outlet line is extending vertically from the thermal hydrocarbon removal unit, relative to a horizontal base.

According to some embodiments, the outlet line is coupled to a temperature controlling apparatus configured to cool the vapors conveyed therethrough.

According to some embodiments, the liquid outlet is in fluid communication with a storage reflux tank configured to store the second hydrocarbon liquid product flowing thereto.

According to some embodiments, the system further comprises a controller in operative communication with one or more system components selected from the cooling unit, heating device, actuator, valve, vacuum pump, and combinations thereof. According to further embodiments, the system further comprises one or more sensors coupled to the system and in operative communication with the controller.

According to some embodiments, the contaminated solids comprise one or more of soil, particles and granules, including porous particles, which are contaminated with petroleum hydrocarbons. According to some embodiments, the petroleum hydrocarbons comprise one or more of heavy crude oil, light crude oil, fractions thereof, and combination thereof. According to some embodiments, the contaminated solids further comprise heavy metals and/or chemical residues disposed therein.

According to some embodiments, the first hydrocarbon liquid product comprises light oil, and the second hydrocarbon liquid product comprises heavy oil.

According to some embodiments, the first portion of the hydrocarbon vapors within the cooling unit, which condenses back into a liquid form, is about 50-99 wt. % or more of the vapors flowing into the cooling unit. According to further embodiments, the first portion of the hydrocarbon vapors within the cooling unit, which condenses back into a liquid form, is about 95-99 wt. % or more of the vapors flowing into the cooling unit.

According to some embodiments, the second portion of the hydrocarbon vapors which did not condense is about 1-50 wt. % or less of the vapors. According to further embodiments, the second portion of the hydrocarbon vapors which did not condense is about 1-5 wt. % or less of the vapors.

According to some embodiments, the first fraction is about 30-95 wt. % of the condensed hydrocarbon vapors, and the second fraction is about 5-70 wt. % of the condensed hydrocarbon vapors. According to further embodiments, the first fraction is about 60-80 wt. % of the condensed hydrocarbon vapors, and the second fraction is about 20-40 wt. % of the condensed hydrocarbon vapors.

According to some embodiments, the hot gas is in a temperature selected from the range of about 100-1000° C.

According to some embodiments, the at least one thermal hydrocarbon removal unit is sealed under vacuum or under reduced pressure. According to some embodiments, the at least one thermal hydrocarbon removal unit is in fluid communication with a gas system or apparatus configured to provide a non-oxidizing gas thereto.

According to some embodiments, the system comprises a plurality of thermal hydrocarbon removal units connected in a series and in solid-fluid communication with each other, wherein each thermal hydrocarbon removal unit is in solid-fluid communication with at least one cooling unit via at least one corresponding outlet line, thus providing a first and a second hydrocarbon liquid products from each thermal hydrocarbon removal unit.

According to another aspect, there is provided a method for recovering hydrocarbon compounds from contaminated solids, the method comprising: (a) providing contaminated solids into a system comprising at least one thermal hydrocarbon removal unit which is in solid-fluid communication with at least one cooling unit via at least one outlet line; (b) conveying the contaminated solids through the at least one thermal hydrocarbon removal unit;

(c) evaporating volatile hydrocarbon compounds from the solids within the thermal hydrocarbon removal unit into the cooling unit, thus at least partially decontaminating the solids; (d) condensing a first portion of the hydrocarbon vapors within the cooling unit; (e) conveying a first fraction of the condensed hydrocarbon vapors of step (d) into a liquid tank, thereby forming a first hydrocarbon liquid product therein; (f) conveying a second fraction of condensed hydrocarbon vapors of step (d) back into the thermal hydrocarbon removal unit, thereby recirculating a reflux stream which flows downwards into the thermal hydrocarbon removal unit; (g) transporting the solids from a first edge of the thermal hydrocarbon removal unit upwards towards a second edge thereof while washing the solids with the reflux stream of step (f) flowing downwards therein, thus at least partially decontaminating the solids; (h) discharging the reflux stream out from the thermal hydrocarbon removal unit following step (g), thus providing a second hydrocarbon liquid product; and (i) discharging the decontaminated solids out from the thermal hydrocarbon removal unit, following the decontamination performed during steps (c) and (g), thus providing a decontaminated solid product.

According to some embodiments, step (b) further comprises indirectly heating the contaminated solids within the thermal hydrocarbon removal unit by a hot gas, wherein the gas is heated to a temperature selected from the range of about 100-1000° C., while simultaneously transporting or conveying the solids upwards within said inner space within the thermal hydrocarbon removal unit.

According to some embodiments, the thermal hydrocarbon removal unit is an inclined elongated double tube, wherein the contaminated solids are conveyed through an inner tube using a rotating screw coupled to at least one actuator, while hot gas is conveyed through a space positioned between an outer tube and the inner tube.

According to some embodiments, step (d) further comprises discharging a second portion of the hydrocarbon vapors which does not condense into the external environment, optionally via an abatement system.

According to some embodiments, the system in step (a) comprises a plurality of thermal hydrocarbon removal units connected in a series and in solid-fluid communication with each other, wherein each thermal hydrocarbon removal unit is in solid-fluid communication with at least one cooling unit via at least one corresponding outlet line, and step (b) comprises conveying the contaminated solids through the plurality of thermal hydrocarbon removal units.

According to some embodiments, step (c) comprises heating each thermal hydrocarbon removal unit to a different temperature and evaporating volatile hydrocarbon compounds from the solids within each thermal hydrocarbon removal unit into each corresponding cooling unit, thus enabling to produce a first hydrocarbon liquid product in step (e) and a second hydrocarbon liquid product in step (h) from each thermal hydrocarbon removal unit.

Certain embodiments of the present invention may include some, all, or none of the above advantages. Further advantages may be readily apparent to those skilled in the art from the figures, descriptions, and claims included herein. Aspects and embodiments of the invention are further described in the specification herein below and in the appended claims.

Unless otherwise defined, all technical and scientific terms used herein have the same meaning as commonly understood by one of ordinary skill in the art to which this invention pertains. In case of conflict, the patent specification, including definitions, governs. As used herein, the indefinite articles “a” and “an” mean “at least one” or “one or more” unless the context clearly dictates otherwise.

The following embodiments and aspects thereof are described and illustrated in conjunction with systems, tools and methods which are meant to be exemplary and illustrative, but not limiting in scope. In various embodiments, one or more of the above-described problems have been reduced or eliminated, while other embodiments are directed to other advantages or improvements.

### BRIEF DESCRIPTION OF THE FIGURES

Some embodiments of the invention are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the invention. For the sake of clarity, some objects depicted in the figures are not to scale.

In the Figures:

FIG. 1 schematically illustrates a system 100 for decontaminating solids from hydrocarbon compounds and recovering the hydrocarbon compounds, according to some embodiments.

FIG. 2 schematically illustrates a system 150, which includes two thermal hydrocarbon removal units, for decontaminating solids from hydrocarbon compounds and recovering the hydrocarbon compounds, according to some embodiments.

FIG. 3 shows a method 200 for decontaminating solids from hydrocarbon compounds and recovering the hydrocarbon compounds, based on system 100, according to some embodiments.

### DETAILED DESCRIPTION OF SOME EMBODIMENTS

The present disclosure is directed toward systems and methods for decontaminating solids (i.e., soil, particles, granules, porous particles, etc.) from hydrocarbon compounds and recovering at least a portion of the hydrocarbon compounds, specifically via the use of thermal hydrocarbon removal systems or devices.

In the following description, various aspects of the disclosure will be described. For the purpose of explanation, specific configurations and details are set forth in order to provide a thorough understanding of the different aspects of the disclosure. However, it will also be apparent to one skilled in the art that the disclosure may be practiced without specific details being presented herein. Furthermore, well-known features may be omitted or simplified in order not to obscure the disclosure.

Throughout the figures different superscripts for the same reference numerals are used to denote different embodiments of the same elements. Embodiments of the disclosed devices and systems may include any combination of different embodiments of the same elements. Specifically, any reference to an element without a superscript may refer to any alternative embodiment of the same element denoted with a superscript. In order to avoid undue clutter from having too many reference numbers and lead lines on a particular drawing, some components will be introduced via one or more drawings and not explicitly identified in every subsequent drawing that contains that component.

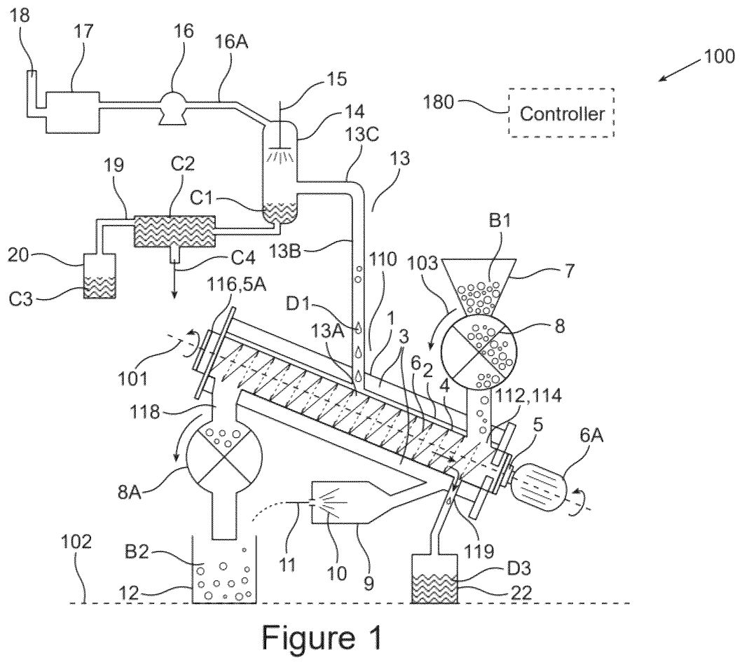

Reference is now made to FIG. 1 illustrating a system 100 for decontaminating solids from hydrocarbon compounds and recovering the hydrocarbon compounds, according to some embodiments.

According to a first aspect, there is provided a system 100 configured to perform decontamination of contaminated solids from hydrocarbon compounds and/or recovery of hydrocarbon compounds from the contaminated solids following the decontamination process.

According to some embodiments, the contaminated solids comprise soil comprising one or more of sand, clay, rock, tar, petrocoke, and combinations thereof. According to some embodiments, the contaminated solids comprise particles which are selected from the group consisting of: earth soil, sludge, filter cake, industrial catalysts, petrocoke, granules, porous particles, other contaminated solid waste materials, and combinations thereof. Each possibility represents a different embodiment. The term “porous particles” as used herein refers to particles having a porous inner structure which may be the result of extrusion or naturally formed, such as silica, alumina, clay, and porous metals.

According to some embodiments, the particles are circular shaped, and have a diameter of less than about 100 mm. In further such embodiments, the diameter of the circular particles is less than about 10 mm, alternatively less than about 1 mm, or optionally less than about 0.1 mm. In some embodiments, the diameter of the circular particles is selected from the range of 0.1-100 mm, including each value and sub-range within the specified range.

According to other embodiments, the particles are characterized by having an elongated shape having a long dimension of less than about 100 mm. In further such embodiments, the long dimension of the elongated particles is less than about 10 mm, alternatively less than about 1 mm, or optionally less than about 0.1 mm. In some embodiments, the long dimension of the elongated particles is selected from the range of 0.1-100 mm. The elongated shape of the particles can be selected from box like, cylinder (tube), or any other polyhedron known in the art. Each possibility represents a different embodiment.

In a specific embodiment, the diameter or long dimension of the particles is selected from the range of about 0.1-100 mm, 1-50 mm and 2-8 mm, including each value and sub-range within the specified range and each possibility represents a separate embodiment of the invention. It should be understood that bigger particles (having a diameter or long dimension above 100 mm) can be treated as well in system 100 as disclosed herein, using first a grinding apparatus which grinds the particles to smaller sizes, and/or by using a thermal hydrocarbon removal unit having bigger dimensions.

According to some embodiments, the hydrocarbon compounds are petroleum hydrocarbons (PHC) which comprise crude oil selected from heavy crude oil, light crude oil (e.g., distillates, gasoil), or both. Petroleum hydrocarbons can be categorized by oil fractions (F1, F2, F3, and F4), which vary based on the number of carbon atoms they contain (increasing number of carbon atoms: F1<F2<F3<F4).

As used herein, the terms “heavy oil” or “heavy crude oil” are interchangeable, and refer to petroleum hydrocarbon liquids which are highly viscous and do not flow easily at room temperature (e.g., F3 and/or F4). Heavy oil has an API gravity value of less than about 20° (optionally less than about) 10° and/or a viscosity value of more than 200 centipoise (cp). As used herein, the terms “light oil” or “light crude oil” are interchangeable, and refer to petroleum hydrocarbon liquids that have low density that flow freely at room temperature (e.g., F1 and/or F2). Light oil has low viscosity, low specific gravity and high API gravity due to the presence of a high proportion of light hydrocarbon fractions. Light oil has an API gravity value greater than about 30° (optionally greater than about) 40°.

According to some embodiments, the petroleum hydrocarbons are selected from the group consisting of: crude oil (heavy and/or light crude oil), gasoline, kerosine, diesel fuels, industrial fuel oil, lubricating oil, other petrochemicals, and combinations thereof. Each possibility represents a different embodiment.

According to some embodiments, the contamination within the solids results from the exposure thereof to petroleum hydrocarbons. The contaminated solids may also include heavy metals, inorganic compounds, other chemical residues, and combinations thereof.

As used herein, the term “contaminated solids” refers to solids which are contaminated with petroleum hydrocarbons. The solids can include soil, particles, granules, and the like. The contamination may further include heavy metals, inorganic compounds, other chemical residues, and combinations thereof. The particles typically have a diameter or a long dimension which is smaller than about 100 mm.

According to some embodiments, system 100 enables to decontaminate contaminated solids from petroleum hydrocarbons (e.g., various oils) and/or to recover petroleum hydrocarbons from contaminated solids, and specifically wherein said petroleum hydrocarbons comprise heavy oil. Furthermore, system 100 optionally enables to perform the decontamination and/or recovery of heavy metals and/or other chemical residues from the contaminated solids.

According to some embodiments, the hydrocarbon removal may include desorbing a hydrocarbon liquid (e.g., oil) from the contaminated solids (e.g., soil).

With specific reference to FIG. 1, according to some embodiments, system 100 comprises: (a) a thermal hydrocarbon removal unit (110); (b) an outlet line (13); and (c) a cooling unit (14) in solid-fluid communication with the outlet line (13).

According to some embodiments, system 100 is mounted to a horizontal base 102, wherein said horizontal base 102 may be an internal space of a vehicle such as a trailer of a truck or a train cart, so that system 100 may be mobile and transported from site to site. According to other embodiments, system 100 is fixedly mounted on horizontal base 102 at an on-site location, wherein said horizontal base 102 can be the ground or the floor of the on-site location.

According to some embodiments, system 100 comprises a feed pipe or feed tank 7 comprising contaminated solids B1 disposed therein. According to some embodiments, the contaminated solids B1 consists of the contaminated solids as disclosed herein above. According to some embodiments, the contaminated solids B1 are added or poured or deposited or introduced into an opening of the feed tank 7. The feed tank 7 can be in the form of a feed tube, a mobile automobile or portion thereof, such that it can be mounted on a track, train, and the like. Each possibility represents a separate embodiment of the invention. According to some embodiments, feed tank 7 is shaped as a funnel configured to enable the gravitational movement downwards of solids B1 to a bottom portion thereof.

As used herein, the term “downwards” refers to a movement within or in the vicinity of the system 100 in the gravitational direction towards the horizontal base 102, while the term “upwards” refers to a movement in the opposite direction therefrom, accordingly. The terms “higher” and “above” refer to a relative position which is in the upwards direction. Similarly, the terms “lower” and “below” refer to a relative position which is in the downwards direction.

According to some embodiments, feed tank 7 is in solid-fluid communication with other portions of system 100 via lines such as tubes or pipes, via a valve, via a thermal hydrocarbon removal unit, or via any other communication appliance known in the art. Each possibility represents a separate embodiment of the present invention. As used herein, the term “line” refers to an element configured to enable solid-fluid communication therethrough, wherein said line can be in the form of a tube, a pipe, a conduit, a duct, or any other form of line known in the art.

As used herein, the term “fluid communication” refers to a path which allows fluid (e.g., a gas and/or a liquid) to flow between two components of the systems of the present invention, wherein said two components can be directly or indirectly joined to each other, and wherein substantially the entire fluid volume is conveyed between the two components without loss of fluids to the ambient surroundings, save when portions thereof are directed to other regions or components of the system. Similarly, as used herein, the terms “fluidly coupled” or “fluidly connected” are interchangeable, and refers to a connection between two components that allows fluid to flow from one component to the other, wherein said connection may be direct or indirect via an intermediate components enabling fluid flow therethrough (such as via a pipe, a pump, a valve, etc.). The term “fluid” may include a gas and/or a liquid containing small amounts of solid particles suspended therein.

Similarly, as used herein, the term “solid communication” refers to a path which allows solids and/or contaminated solids to be conveyed between at least two components of system 100 of the present invention, wherein said at least two components can be directly or indirectly joined to each other, and wherein substantially the entire solids volume is conveyed between the two components without loss of solids to the ambient surroundings, save when portions thereof are directed to other regions or components of the system. Thus, the term “solid-fluid communication” as used herein, refers to a path which allows fluids and/or solids (e.g., contaminated solids) to be conveyed (directly or indirectly) between at least two components of system 100 of the present invention.

According to some embodiments, feed tank 7 is in solid-fluid communication with a grading apparatus configured to grade or grind the contaminated solids B1 transferring therethrough into smaller particles, having a diameter or a long dimension in the size of below about 100 mm, after the grinding thereof.

According to some embodiments, feed tank 7 is in solid-fluid communication with a valve 8 configured to regulate a release rate of the contaminated solids B1 into additional portions of the system 100. In further such embodiments, valve 8 is a butterfly feeding sealing valve. Valve 8, or any other valve coupled to the system 100, may be a sealing valve which is configured to restrict air inflow into the system and specifically into the thermal hydrocarbon removal unit, thus enabling to reduce the oxidation of solids B1 therein. The presence of air, or any other oxidizing atmosphere, within system 100 is dangerous since it can lead to the burning of the contaminated solids and/or the hydrocarbon vapors therein (specifically under the thermal conduction of heat within the thermal hydrocarbon removal unit). Therefore, according to some embodiments, a non-oxidizing gas (e.g., nitrogen) is added into the thermal hydrocarbon removal unit 110, optionally via valve 8, or any other valve coupled to the system.

According to some embodiments, feed tank 7, or specifically valve 8, is in solid-fluid communication with at least one thermal hydrocarbon removal unit 110 and is configured to transfer the contaminated solids B1 thereto, along direction arrow 103. According to some embodiments, feed tank 7 or specifically valve 8 enables to transfer the contaminated solids B1 to the thermal hydrocarbon removal unit 110 via the utilization of the gravitational force and/or via the use of one or more pumps, motors, or other electric components.

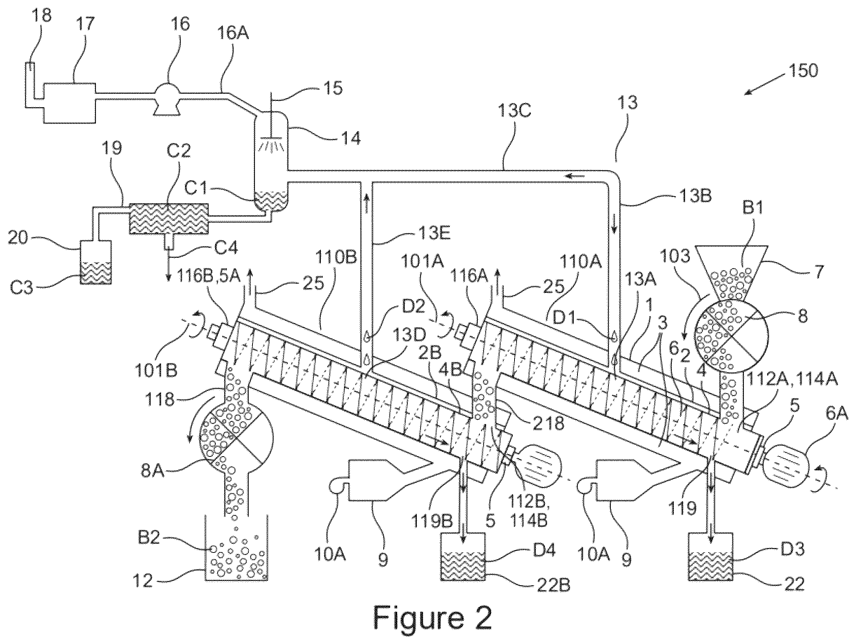

According to some embodiments, system 100 comprises a plurality of thermal hydrocarbon removal units 110, which are in solid-fluid communication with each other and are connected in a series to each other. Specific reference to this option is made in FIG. 2 and discuss herein below.

According to some embodiments, one or more of feed tank 7, valve 8, and hydrocarbon removal unit 110 is in fluid communication with at least one vacuum pump or system (e.g., pump 16). According to some embodiments, the thermal hydrocarbon removal unit 110 is in fluid communication with at least one vacuum pump or system configured to reduce the pressure within the thermal hydrocarbon removal unit 110, to enable to utilize lowered temperatures therein, due to the reduced pressure and thus to enable the effective and economic operation thereof. Furthermore, the at least one vacuum pump or system is further configured to reduce air atmosphere within the hydrocarbon removal unit 110, and/or to prevent air entry thereto. According to some embodiments, at least one of feed tank 7, valve 8, or hydrocarbon removal unit 110 is in fluid communication with at least one vacuum pump or system, to reduce air content therein or to prevent air entry thereto, in order to prevent the oxidation of the contaminated solids B1. According to some embodiments, a non-oxidizing gas (e.g., nitrogen) is added into the thermal hydrocarbon removal unit 110.

According to some embodiments, hydrocarbon removal unit 110 is sealed under vacuum. According to some embodiments, hydrocarbon removal unit 110 is in fluid communication with an inert gas system (not shown in FIG. 1) or apparatus configured to provide a non-oxidizing gas (e.g., nitrogen) thereto, wherein optionally hydrocarbon removal unit 110 is also in fluid communication with at least one vacuum pump (e.g., pump 16 or a separate pump positioned elsewhere) or system configured to reduce the pressure therein.

According to some embodiments, the thermal hydrocarbon removal unit 110 is in the form of an inclined rotating sealed or pressurized drum, where the contaminated solids B1 are conveyed through the drum (under reduced pressure and/or a non-oxidizing gas) using a plurality of lifting flights connected to an inner surface of the drum, while the drum is being heated by burners or at least one electric heating device. According to some embodiments the inclined drum is elongated. According to some embodiments the drum is in the form of a cylinder. According to some embodiments the lifting flights are configured to allow flow of a liquid stream, such as oil reflux stream D1 (described herein), downwards within the drum, optionally counter to the direction in which contaminated solids B1 are being conveyed, to be evacuated from the drum, optionally into an oil reservoir (e.g., liquid container 22). According to some embodiments the lifting flights are perforated and/or curved, to allow liquid to flow downwards there along. According to some embodiments, the oil reservoir may include a one-way valve through which oil reflux stream D1 enters therein, and may further include a vacuum suction source, configured to induce a reduced pressure within the oil reservoir for enhancing flow of the reflux stream towards and into the oil reservoir.

According to other embodiments, the thermal hydrocarbon removal unit 110 is in the form of an inclined elongated double tube 110 or pipe comprising an inner tube 2 and an outer tube 1, wherein the inner tube 2 is disposed within the outer tube 1. According to some embodiments, a longitudinal axis 101 is extending along a center of the inner tube 2, wherein the outer tube 1 is extending circumferentially around the inner tube 2 and further around the longitudinal axis 101.

In some embodiments inner tube 2 is in thermal communication with outer tube 1. The term “thermal communication” as used herein, is defined as a connection between components which allows transferring of heat between the two components, such that when the temperature is adjusted, e.g., elevated, in one of the components it produces an adjustment in the same direction (although not necessarily at the same magnitude), e.g., elevation, of the temperature in the second component. According to some embodiments, the change of temperature induced in the second component may be a percent of the change in the first component. According to some embodiments, the magnitude of the change of temperature in the second component may be at least 10% of the magnitude of the change of temperature in the first component. In other embodiments it may be at least 15%; at least 25%; at least 30%; at least 40%; at least 50%; at least 60%; at least 70%; at least 80%; and at least 90%. Each possibility represents a separate embodiment. According to some embodiments change of temperature in the second component may be dependent on the absolute temperature in the first component.

As used herein, the term “elongated” refers to a shape having a long dimension and a short dimension, wherein the long dimension thereof (e.g., length) is greater than the short dimension (e.g., width or diameter) thereof. For example, the length of an elongated tube may be at least three times, at least five times, at least ten times, or more, greater than of the width or diameter thereof.

According to some embodiments, the elongated double tube 110 extends from a first edge 114 towards a second edge 116, along the longitudinal axis 101. According to some embodiments, the elongated double tube 110 is cylinder-shaped. However, it is to be understood that the elongated double tube 110 may have any other external shape, such as a box, ellipsoid, or any other polyhedron known in the art. Each possibility represents a different embodiment.

According to some embodiments, the elongated double tube 110 is inclined so that the distance between the second edge 116 and the horizontal base 102 is greater than the distance between the first edge 114 and the horizontal base 102. According to some embodiments, the elongated double tube 110 is inclined so that the second edge 116 is positioned higher than the first edge 114, relative to the horizontal base 102. According to some embodiments, the longitudinal axis 101 (extending through the elongated double tube 110) is inclined relative to the horizontal base 102, so that an axis inclination angle in the range of about 10-90° is formed therebetween.

According to some embodiments, the outer tube 1 of the elongated double tube 110 defines an intermediate space 3 therein, and is configured to enable the flow of a hot fluid (e.g., gas) therethrough. Said intermediate space 3 is defined between an external wall of outer tube 1 and an external wall of the inner tube 2. According to some embodiments, the intermediate space 3 of outer tube 1 is in fluid communication with a heating device 9 (e.g., a burner). According to some embodiments, heating device 9 is coupled to a fuel inlet pipe 11 enabling to receive fuel from a fuel source, thus producing a flame 10 within the heating device 9 which is configured to produce a hot gas. The hot gas may be the product of the burning of flame 10, and/or may other gas which is in fluid communication with heating device 9 and is heated by flame 10. The hot gas then flows into the intermediate space 3 of outer tube 1. According to further embodiments, said hydrocarbons comprise one or more hydrocarbon gases selected from the group consisting of: methane, propane, butane, ethane, other suitable gases, and combinations thereof. According to some embodiments, at least a portion of the fuel utilized by heating device 9 may originate in the contaminated solids B1 that are treated by the system 100. Hydrocarbon gases may be extracted by the purification process of solids B1 and collected as hydrocarbon liquids C3 and/or D3, as further explained herein, and supplied to fuel inlet 11. According to some further embodiments, the hot fluid flowing within intermediate space 3 may include hot liquid such as molten salt or oil.

According to other embodiments, heating device 9 is heated by an electric heating device, which generates the hot gas.

According to further embodiments, heating device 9 is heated by an electric heating device, which heats the inner tube directly. According to such embodiments, for example, it is optional that hydrocarbon removal unit will include only inner tube 2, and will not further include outer tube 1.

According to some embodiments, the hot gas flowing through the inner intermediate 3 of outer tube 1 is heated to a temperature in the range of 100-1000° C., or more, including each value and sub-range within the specified range. According to further embodiments, the hot gas flowing through the intermediate space 3 of outer tube 1 is heated to a temperature in the range of 200-900° C., alternatively 500-800° C., or optionally 650-750° C. Each possibility represents a different embodiment. In a specific embodiment, the temperature is about 700° C.

According to alternative embodiments, system 100 is devoid of the heating device 9. According to some embodiments, system 100 comprises, instead or in addition to the device 9, at least one heating element (e.g., a heating coil, heating spiral etc.; not show in FIG. 1) which is disposed within the intermediate space 3, and is configured to generate heat therein, which is transferred to solids B1 within the inner tube 2. According to some embodiments the heating element is heated by an electric current flowing therethrough.

According to some embodiments, the inner tube 2 is disposed within the intermediate space 3 of outer tube 1 and is extending there along. According to some embodiments, the inner tube 2 defines an internal inner space 4 therein.

According to some embodiments, a solids inlet opening 112 is extending through the inner tube 2 in the proximity of the first edge 114 thereof and is in solid-fluid communication with the feed tank 7, thus enabling to transfer or insert or deposit solids B1 from feed tank 7 into the inner space 4 of the inner tube 2.

As used herein, the term “proximity” refers to a distance within a radius of less than about 1 m of a given three-dimensional (3D) space. According to some embodiments, the term “proximity” refers to a distance within a radius of less than about 50 cm, optionally less than about 1 cm, or alternatively less than about 0.1 cm of a given 3D space. Each possibility represents a separate embodiment of the present invention.

According to some embodiments, inner space 4 of inner tube 2 comprises a non-oxidizing gas (e.g., nitrogen) flowing thereto.

According to some embodiments, inner space 4 of inner tube 2 comprises transportation means 6 disposed therein, configured to transport or convey the contaminated solids B1 within the inner tube 2, from the proximity of the first edge 114 of the elongated double tube 110 upwards towards the second edge 116 thereof, along the longitudinal axis 101. According to some embodiments, transportation means 6 comprises a rotating spiral screw (e.g., an auger), a moving conveyor belt, or other transportation means known in the art. Each possibility represents a separate embodiment of the invention. According to some embodiments, transportation means 6 is a rotating screw 6, wherein screw 6 is configured to rotate within the inner space 4 of inner tube 2 and to rotationally transport solids B1 therein from the first edge 114 towards the second edge 116 thereof. According to further embodiments, the contaminated solids B1 are conveyed or transported via rotational movement by the rotating screw 6, upwards within the inner space 4 of inner tube 2.

According to some embodiments, transportation means 6 (e.g., rotating screw 6) is coupled to an actuator 6A configured to generate the rotational movement of the transportation means 6 around the longitudinal axis 101.

The term “actuator”, as used herein, refers to any powered actuator known in the art for providing rotational motion, such as an electric motor, a solenoid, an air actuated motor, and the like. According to some embodiments, the actuator 6A is an electronic actuator. According to some embodiments, the actuator 6A is a hydrocarbon fuel operated motor. According to some embodiments, the motor comprises a fuel tank (not shown) for containing the hydrocarbon fuel required for its operation.

According to some embodiments, the thermal hydrocarbon removal unit 110 comprises a seal 5 positioned in proximity to the first edge 114, configured to prevent solids B1 from entering into or contact the actuator 6A. According to some embodiments, the thermal hydrocarbon removal unit 110 comprises a seal portion 5a positioned in proximity to the second edge 116, configured to prevent spillage therefrom and further configured to prevent from air to enter into the inner space 4 of inner tube 2.

According to some embodiments, heat (or thermal energy) is transferred from the hot gas flowing through the intermediate space 3 of outer tube 1, via a thermally conducting wall of the inner tube 2, into the inner space 4 thereof and further into solids B1 transported therethrough. As a result from the heating of the inner space 4 of inner tube 2 (via thermal conduction), the temperature therein is heated to a temperature in the range of about 40-900° C., optionally 120-800° C., or optionally 150-600° C. Each possibility represents a different embodiment.

Due to the indirect heating, volatile hydrocarbon compounds are separated as vapors from solids B1 and flow (or are drawn under vacuum) through at least one vapor outlet opening 13A into at least one corresponding outlet line 13. According to some embodiments, at least one outlet line 13 is in solid-fluid communication with the inner space 4 of inner tube 2 via the outlet opening 13A. Advantageously, the evaporation of volatile hydrocarbon compounds from solids B1 within thermal hydrocarbon removal unit 110 during the operation of system 100 as disclosed herein, enables to at least partially decontaminate solids B1 from contaminations (in the form of the hydrocarbon vapors) and to recover hydrocarbon vapors.

According to some embodiments, the rotation of transportation means 6 within the inner space 4 of inner tube 2 allows to rotationally transport or convey solids B1 therein from the first edge 114 towards the second edge 116 thereof, and further enables the volatile hydrocarbon vapors formed therein to be release into the outlet line 13. Advantageously, the rotation of transportation means 6 prevents the volatile hydrocarbon vapors from becoming trapped within the inner space 4 of inner tube 2.

According to some embodiments, inner space 4 of inner tube 2 is in solid-fluid communication via a solids outlet opening 118 to a valve 8A, positioned in proximity to the second edge 116. When solids B1 are in proximity of the second edge 116, solids B1 fall or are discharged via opening 118 and through valve 8A into a decontaminated solid tank 12. Alternatively or additionally, once substantially all hydrocarbon compounds have been removed from solids B1, solids B1 are discharged through valve 8A into a decontaminated solid tank 12. Similarly to valve 8, valve 8A may be a sealing valve which is configured to restrict air, particularly oxygen, inflow into the system and specifically into the hydrocarbon removal unit, thus enabling to reduce the oxidation of solids B1 therein. According to some embodiments, the decontaminated solid tank 12 comprises decontaminated solid particles or soil which are substantially devoid or devoid of any contamination, denoted B2. According to some embodiments, decontaminated solid tank 12 is in solid-fluid communication with inner space 4 of inner tube 2. According to some embodiments, valve 8A is configured to regulate a release rate of solids B1 into the decontaminated solid tank 12, wherein valve 8A is optionally a butterfly or other discharge sealing valve.

As used herein, the term “substantially devoid” refers to a composition which comprises no more than 5% w/w, no more than 3% w/w, or no more than 1% w/w of a specified material. Thus, the phrase “substantially devoid or devoid of any contamination” in the context of the present invention means that the decontaminated solids include no more than 5% w/w, no more than 3% w/w, or no more than 1% w/w hydrocarbons. Each possibility represents a separate embodiment of the invention.

According to some embodiments, decontaminated solids B1 are stored within the decontaminated solid tank 12, and optionally can be transferred to be processed in additional processing unit(s) for various uses.

According to some embodiments, the outlet line 13 is fluidly coupled to at least one condensing or cooling unit 14, wherein outlet line 13 enables the vapors to flow into cooling unit 14. According to further embodiments, cooling unit 14 is configured to cool and/or to condense back into liquid form at least a portion of the hydrocarbon vapors transferred or conveyed thereto.

According to some embodiments, cooling unit 14 (e.g., a quencher) comprises at least one water spray system 15 (e.g., a sprinkler) configured to spray water to cool and/or condense at least a portion of the hydrocarbon vapors therein. According to other embodiments, water spray system 15 is configured to wash the hydrocarbon vapors to reduce the quantity of polluting particles therefrom.

According to other embodiments, cooling unit 14 comprises an additional or different cooling apparatus or system disposed therein, which is configured to condense at least a portion of the hydrocarbon vapors therein. According to other embodiments, cooling unit 14 is made of a plurality of pipes which are cooled by a cold liquid or gas (e.g., a heat exchanger; not shown in FIG. 1).

According to some embodiments, cooling unit 14 is in solid-fluid communication with the inner space 4 of inner tube 2 via the outlet line 13.

A first portion of the hydrocarbon vapors within the cooling unit 14 condenses back into a liquid form, to produce a mixture of water and condensed hydrocarbon vapors as a liquid mixture C1 (e.g., water and oil) disposed at the bottom of the cooling unit 14. Liquid mixture C1 can include a mixture of condensed hydrocarbon vapors and water originating from the water spray system 15 and/or from other sources.

According to some embodiments, the first portion of the hydrocarbon vapors within the cooling unit 14, which condenses back into a liquid form, constitutes as about 50-99 wt. % or more of the vapors flowing into the cooling unit 14 from outlet line 13. According to further embodiments, the first portion of the hydrocarbon vapors constitutes as about 50-80 wt. %, about 80-90 wt. %, about 90-99 wt. %, or more, of the vapors. Each possibility represents a different embodiment. According to still further embodiments, the first portion of the hydrocarbon vapors constitutes as about 95-99 wt. % of the vapors. According to a specific embodiment, the first portion of the hydrocarbon vapors is about 99 wt. % or more of the vapors.

According to some embodiments, a first fraction of the liquid mixture C1 transfers into a separator C2 (optionally due to the gravitational force), which is in fluid communication with the cooling unit 14. According to some embodiments, separator C2 is an oil in water separator (based on the different specific gravity the liquids and/or on of the characteristic dissolution of oil in water), configured to separate water from the first fraction of condensed hydrocarbon vapors of mixture C1. After the separation, water flow out therefrom through water outlet C4, while the condensed hydrocarbon vapors flow via a liquid outlet line 19 and are transferred or conveyed into a liquid tank 20, thus producing a first hydrocarbon liquid product C3. Thus, liquid tank 20 comprises condensed hydrocarbon vapors or the first hydrocarbon liquid product C3 therein (e.g., oil). According to some embodiments, separator C2 is in fluid communication with the liquid tank 20.

According to some embodiments, the first fraction which is transferred into the separator C2 constitutes about 30-95 wt. % of the liquid mixture C1. According to further embodiments, the first fraction which is transferred into the separator C2 constitutes about 50-90 wt. %, optionally 60-80 wt. %, or alternatively 65-75 wt. % of the liquid mixture C1. Each possibility represents a different embodiment. In a specific embodiment, the first fraction which is transferred into the separator C2 constitutes as about 70 wt. % of the liquid mixture C1.

According to some embodiments, the first hydrocarbon liquid product C3 comprises light oil, such as: diesel, gasoline, F1, F2, etc. In some embodiments liquid tank 20 is in fluid communication with fuel inlet pipe 11 and/or with a fuel operated motor of actuator 6A, and liquid product C3 is utilized as a fuel for producing flame 10 within heating device 9, and/or for powering the motor of actuator 6A, respectively.

According to some embodiments, a second portion of the hydrocarbon vapors within the cooling unit 14 does not condense, and said hydrocarbon vapors are transferred or conveyed via an outlet gas pipe 16A into a vacuum pump 16, and then into an abatement system 17. According to further embodiments, abatement system 17 is a gas-air abatement system (e.g., a scrubber or an oxidizer such as activated carbon), which is configured to detoxify the gases transferred therethrough and discharge them safely via a gas outlet pipe 18 into the external environment (e.g., atmosphere). The gases discharge via gas outlet pipe 18 into the external environment may contain organic compounds, inorganic compounds, and combinations thereof. For example, the gas may include SOx compounds (e.g., sulfur dioxide or sulfur trioxide). According to some embodiments, the gases discharge via gas outlet pipe 18 into the external environment are substantially devoid of hydrocarbons). According to some embodiments, abatement system 17 is a scrubber which is positioned horizontally in parallel to the horizontal base 102. According to some embodiments, cooling unit 14 is in fluid communication with the abatement system 17.

According to some embodiments, one or more of outlet line 13, outlet gas pipe 16A, gas outlet pipe 18, and any other pipe or line within system 100, comprise at least one particle filter (e.g., activated carbon) configured to remove polluting particles from the vapors passing therethrough.

According to some embodiments, the second portion of the hydrocarbon vapors within the cooling unit 14, which does not condense, constitutes as about 1-50 wt. % or less of the vapors within the cooling unit 14. According to further embodiments, the second portion of the hydrocarbon vapors constitutes about 1-10 wt. % of the vapors within into the cooling unit 14. According to still further embodiments, the second portion of the hydrocarbon vapors constitutes about 1-5 wt. % or less of the vapors within the cooling unit 14. According to a specific embodiment, the second portion of the hydrocarbon vapors is about 1 wt. % or less of the vapors.

According to some embodiments, vacuum pump 16 is further configured to convey or draw the hydrocarbon vapors, under vacuum, from the inner space 4 of inner tube 2 into the outlet line 13. According to some embodiments, vacuum pump 16 is further configured to reduce the pressure within the inner space 4 of inner tube 2, thus enabling to heat the hot gas conveyed or flowing through the intermediate space 3 of outer tube 1 to lower temperatures (due to the reduced pressure), and still enable to effectively transfer heat to solids B1 disposed within the inner space 4 to achieve the required evaporation therefrom, as disclosed herein above. According to some embodiments, vacuum pump 16 is further configured to reduce air atmosphere within the hydrocarbon removal unit 110 or to prevent air entry thereto. Hazards related to entry of air and oxygen into the system 100 are elaborated above.

According to some embodiments, a second fraction of the liquid mixture C1 from the cooling unit 14 contains heavier hydrocarbons than the first fraction. Thus, according to some embodiments, it is not transferred into separator C2, and instead it condenses and transferred or redirected or recirculated back into outlet line 13, thus forming a reflux stream D1 optionally consisting of water and condensed hydrocarbon vapors which is conveyed or flows downward through outlet line 13 back into the inner space 4 of inner tube 2.

According to some embodiments, the second fraction which is recirculated back into outlet line 13, thus forming a reflux stream D1, constitutes about 5-70 wt. % of the liquid mixture C1. According to further embodiments, the second fraction which forms the reflux stream D1 constitutes about 10-50 wt. %, optionally 20-40 wt. %, or alternatively 25-35 wt. % of the liquid mixture C1. Each possibility represents a different embodiment. In a specific embodiment, the second fraction which forms the reflux stream D1 constitutes as about 30 wt. % of the liquid mixture C1. It is to be understood by the person having ordinary skill in the art that the relative ratio between the first and second fraction depends on the hydrocarbon composition contaminating the solids B1.

According to some embodiments, the outlet line 13 is in solid-fluid communication via the outlet opening 13A with the inner space 4 of inner tube 2 of hydrocarbon removal unit 110. According to some embodiments, outlet line 13 is extending from the hydrocarbon removal unit 110, vertically relative to the longitudinal axis 101 or to the horizontal base 102. According to some embodiments, outlet line 13 is extending from the hydrocarbon removal unit 110, in an outlet line angle selected from 10-90° relative to the longitudinal axis 101, or to the horizontal base 102. It is contemplated in some embodiments, that orienting the outlet line 13 in an outlet line angle selected from 10-90° relative to the longitudinal axis 101 or to the horizontal base 102, i.e., non-horizontally, enables the fluids of reflux stream D1 to easily flow downward therethrough by virtue of the gravitational force, from the direction of cooling unit 14 towards hydrocarbon removal unit 110, and to enter into the inner space 4 of the inner tube 2.

According to some embodiments, outlet line 13 comprises at least two sections: a first section 13B which extends from the hydrocarbon removal unit 110 towards a line bending, and a second section 13C which extends from the line bending towards the cooling unit 14. According to some embodiments, the second section 13C has a diameter which is smaller than a diameter of the first section 13B, by at least 5%. In further such embodiments, the diameter of the second section 13C is smaller than the diameter of the first section 13B by at least 10%, at least 20%, at least 30%, at least 40%, at least 50%, or more. It is contemplated, that the bigger diameter of the first section 13B, combined with the optional cooling of the first section 13B of outlet line 13, enables at least partial condensation of the vapor flowing therethrough mainly on the wall of first section 13B and thus at least partially forms the reflux stream D1 which flows downward therethrough and enters into the inner space 4 of the inner tube 2. Since the second section 13C optionally transfers mainly vapors, it can have a smaller diameter relative to the first section 13B.

According to some embodiments, outlet line 13 is coupled to a temperature controlling apparatus (e.g., a heat exchanger, a cooling element, etc.), in order to regulate (and specifically to cool) the temperature therein. According to some embodiments, outlet line 13 is coupled to a heat exchanger, configured to cool the outlet line 13, resulting in partial condensation of the vapors conveyed or flowing therethrough. According to some embodiments, outlet line 13 is coupled to a cold gas source or generator. According to some embodiments, cold nitrogen gas is added into the first section 13B of outlet line 13, resulting in partial condensation of the vapors conveyed or flowing therethrough, and the partial formation of reflux stream D1 which flows back into the inner space 4 of inner tube 2, contact solids B1 therein, and washes and/or dissolves at least partially the contamination (e.g., heavy oil) therefrom, and into a liquid container 22.

According to some embodiments, first section 13B of outlet line 13 extends from the hydrocarbon removal unit 110, vertically relative to the longitudinal axis 101 or to the horizontal base 102. According to some embodiments, first section 13B of outlet line 13 has a length which is greater than about 0.5 m, preferably greater than about 1 m, or more preferably greater than about 1.5 m. According to further embodiments, the length of first section 13B of outlet line 13 is in the range of about 0.5-10 m. According to still further embodiments, the length of first section 13B of outlet line 13 is in the range of about 1-5 m. According to yet still further embodiments, the length of first section 13B of outlet line 13 is in the range of about 1-2 m. It is contemplated, in some embodiments, that the combination between cooling the first section 13B of outlet line 13 and having a length thereof in the range of about 1-5 m (preferably in the range of 1-2 m), enables the at least the partial condensation of the vapors conveyed or flowing therethrough and the beneficial partial formation of reflux stream D1 therein.

According to some embodiments, the reflux stream D1 comprises condensed hydrocarbon vapors of heavy oil. According to some embodiments, the reflux stream D1 comprises condensed hydrocarbon vapors of light oil.

According to some embodiments, the reflux stream D1 flows downward into the inner space 4 of inner tube 2, and then downward in the direction of the first edge 114 thereof. Due to the inclination of the thermal hydrocarbon removal unit 110, the reflux stream D1 flows downward within the inner space 4 of inner tube 2 (due to the gravitational force).

According to some embodiments, due to the hot temperatures residing within the inner space 4 of inner tube 2 (optionally due to hot gas flowing through the intermediate space 3 of outer tube 1, as disclosed herein above), water can be evaporated from the reflux stream D1 back into the outlet line 13.

The condensed hydrocarbon vapors of reflux stream D1 flows downwards along the inner space 4 of inner tube 2 in the direction of the first edge 114 thereof, exits inner space 4 through a liquid outlet 119 in fluid communication therewith, and finally accumulates within a liquid container 22 which is in fluid communication therewith. According to some embodiments, liquid container 22 comprises hydrocarbon oil condensed from the reflux stream D1 vapors. Said oil is also defined as a second hydrocarbon liquid product D3 (e.g., oil). According to further embodiments, second hydrocarbon liquid product D3 comprises heavy oil, such as: F3 and/or F4.

Without wishing to be bound by any theory of mechanism of action, during the downward flow of the condensed hydrocarbon vapors (i.e., reflux stream D1), the condensed hydrocarbon vapors contact solids B1 transported upwards within the inner tube 2 via the transportation means 6. During the contact between the condensed hydrocarbon vapors of reflux stream D1 and solids B1, the reflux stream D1 is capable of washing and/or dissolving/removing at least part of the contamination (e.g., organic compounds, inorganic compounds (like sulfur compounds), etc.) therefrom, thus producing at least partially decontaminate solids. Advantageously, the recirculated reflux stream D1 comprises condensed hydrocarbon vapors, which flows downwards within the thermal hydrocarbon removal unit 110 and contact solids B1 transported therethrough, enables to decontaminate solids B1 from contaminations and to recover the condensed hydrocarbon vapors, as disclosed above. Specifically, in some embodiments, the recirculated reflux stream D1 (comprising condensed hydrocarbon vapors) is able to wash, to dissolve, and to remove heavy oil contamination (e.g., petrocoke) from solids B1.

In some embodiments, the recirculated reflux stream D1 may improve the quality of the hydrocarbon product of the system, e.g., oil which is accumulated in liquid tank 20 and/or liquid container 22. For example, in embodiments where the contaminated solids treated in the hydrocarbon removal unit 110 include spent catalyst from a cracking refinery, the reflux stream flowing downwards within the hydrocarbon removal unit 110 may wash the catalyst, which may then react with the hydrocarbons at the elevated temperature within the hydrocarbon removal unit and break the long chains into shorter one, thus increasing the amount of produced oil while lowering the density of the oil.

Furthermore, due to the fact that the recirculated reflux stream D1 comprises condensed hydrocarbon vapors, the hydrocarbon contamination residing therein is not transferred into the abatement system 17, and thus enables reducing emissions of pollutants residing within the hydrocarbon vapors via outlet pipe 18. Advantageously, due to the utilization of the recirculated reflux stream D1 within system 100, the polluting emissions via outlet pipe 18 is significantly reduced. Moreover, the utilization of the recirculated reflux stream D1 enables to significantly reduce the second portion of the hydrocarbon vapors within the cooling unit 14 (which did not condense and is released into the external environment) to about 5 wt. % or less, or preferably to about 1 wt. % or less. Thus, the utilization of the reflux stream D1 enables to reduce the polluting emissions within the reduced amount of vapors, which are released into the external environment.

According to some embodiments, the utilization of the recirculated reflux stream D1 enables system 100 to reduce polluting emission by at least 10%, at least 20%, at least 30%, at least 40%, at least 50%, at least 60%, at least 75%, at least 90% or more. In further such embodiments, the utilization of the recirculated reflux stream D1 enables system 100 to reduce polluting emission by about 40% or more.

It is contemplated that system 100 of the present invention is specifically designed to permit maximum separation of polluting hydrocarbons from contaminated solids during a single pass of the solids through the thermal hydrocarbon removal unit 110. According to some embodiments, system 100 as disclosed herein provides two beneficial decontamination routes which enable decontamination of solids B1: (1) due to the heating performed within thermal hydrocarbon removal unit 110 which vaporize volatile hydrocarbon compounds from solids B1; and (2) due to the contact between the condensed hydrocarbon vapors of reflux stream D1 (flowing down within thermal hydrocarbon removal unit 110) and solids B1. Therefore, said two decontamination routes enable decontaminating solids B1 in an effective and an economic manner.

According to some embodiments, the utilization of reflux stream D1 further allows to provide at least one additional output hydrocarbon liquid product, wherein the first hydrocarbon liquid product is disposed within liquid tank 20, and the second hydrocarbon liquid product is disposed within liquid container 22, as disclosed above. Said hydrocarbon liquid products can be oil or any fraction thereof. According to some embodiments, liquid container 22 is in fluid communication with fuel inlet pipe 11 and/or with a motor of actuator 6A, and the second hydrocarbon product D3 is utilized as a fuel for producing flame 10 within heating device 9, and/or for powering the motor of actuator 6A, respectively.

According to some embodiments, one or more of outlet line 13, outlet gas pipe 16A, gas outlet pipe 18, water outlet C4, or any other pipe or line within system 100, comprise an external thermal insulation layer. Each possibility represents a separate embodiment of the invention.

According to some embodiments, system 100 operates in a continuous mode or in a batch mode.

According to some embodiments, system 100 is connected in a series and in solid-fluid communication with at least one additional similar system, in order to allow a higher production rate of hydrocarbon liquid products. According to further embodiments, system 100 is connected in a series and in solid-fluid communication with a plurality of additional similar systems. Each system can be heated to a different temperature to enable to condense and recover different fractions of hydrocarbon vapors (having different condensation temperatures).

According to some embodiments, system 100 comprises a plurality of thermal hydrocarbon removal units 110 connected in a series and in solid-fluid communication with each other, wherein each thermal hydrocarbon removal unit 110 is in solid-fluid communication with at least one corresponding cooling unit 14 and in fluid communication with at least one corresponding heating device 9, thus enabling to heat each thermal hydrocarbon removal unit 110 to a different temperature, resulting in the condensation and recovery of different fractions of hydrocarbon vapors. In further such embodiments, system 100 comprises at least two, at least three, at least four, or at least five thermal hydrocarbon removal units 110 connected in a series and in solid-fluid communication with each other. Advantageously, it is contemplated that the serial connection of a plurality of thermal hydrocarbon removal units 110 as disclose herein above, can enable to insert a greater amount of contaminated solids B1 into system 100, and thus to produce or recover greater amounts of hydrocarbon liquid products, and optionally to recover different fractions thereof (from each thermal hydrocarbon removal unit 110). Reference to this specific multiple thermal hydrocarbon removal units 110 configuration is elaborated below when referring to FIG. 2.

According to some embodiments, system 100 may comprise one or more components selected from valves, pumps, sensors, and combinations thereof, which may be coupled to various portions within the system, wherein said components may be in operative communication with a controller 180. The one or more components are not depicted in the figure, for brevity.

According to some embodiments, one or more of outlet line 13, outlet gas pipe 16A, gas outlet pipe 18, water outlet C4, or any other pipe or line within system 100, is coupled to at least one temperature sensor, thus enabling to control/regulate the temperature therein. In further embodiments, said lines and/or pipes are coupled to at least one temperature controlling apparatus (e.g., a heat exchanger), thus enabling to cool or heat these lines and/or pipes, according to system demands. In certain embodiments, outlet line 13 is cooled, in order to enable or affect the condensation of the vapors flowing therethrough, and to enable the formation of reflux stream D1.

According to some embodiments, one or more of heating device 9, intermediate space 3 of outer tube 1, inner space 4 of the inner tube 2, cooling unit 14, outlet line 13, or other portions of system 100, are coupled to at least one temperature sensor (not shown), wherein said at least one temperature sensor is in operative communication with a controller 180 which can control/regulate the temperatures therein.

According to some embodiments, system 100 further comprises a controller 180 (e.g., a computer system) in operative communication with the various components of system 100 (e.g., pumps, valves, motors etc.). According to some embodiments, controller 180 comprises a computer system including, for example, a processor coupled to a tangible, non-transitory memory.

According to some embodiments, controller 180 is in operative communication with one or more system components selected from the group consisting of: valve 8, valve 8A, heating device 9, actuator 6A, vacuum pump 16, water spray system 15, and other components (e.g., valves, pumps, sensors, etc.), and combinations thereof. According to some embodiments, controller 180 controls the operation of the one or more system components as disclose herein above, optionally based on readings from one or more sensors coupled to system 100 or portions thereof. According to some embodiments, controller 180 controls/adjusts the temperature within the hydrocarbon removal unit 110, cooling unit 14, other portions of system 100, and combinations thereof, based on real time sensor data and/or user preprogrammed system requirements.

For example, according to some embodiments, controller 180 is configured to adjust the opening of valve 8 to control the release rate of solids B1 into the hydrocarbon removal unit 110. Additionally, according to some embodiments, controller 180 is configured to adjust the size of the flame 10 within the heating device 9 or vary the power provided thereto, based on readings from at least one temperature sensor, thereby controlling/regulating the temperature within the inner space 4 of inner tube 2. Furthermore, according to some embodiments, controller 180 is configured to adjust the activation and temperature of the water spray system 15, thereby controlling the portion of condensed hydrocarbon vapors within the cooling unit 14. Moreover, according to some embodiments, controller 180 is configured to adjust the operation and rotational speed of actuator 6A, in order to control the speed of rotating screw 6, which affects solids B1 rotational transportation rate within the inner space 4 of inner tube 2.

According to some embodiments, controller 180 is in the form of an operating hand-controller (e.g., cell phone, smartphone, laptop, tablet, etc.) and/or a control panel comprising one or more screens (e.g., touchscreens). The screens or touchscreens may include multiple color screens which may provide visualization of data coming from the sensors or from other system components. According to some embodiments, controller 180 further comprises connection to Ethernet for remote monitoring of process parameters.

According to some embodiments, controller 180 comprises one or more elements selected from a processor (e.g., a central processing unit (CPU)), a graphics processing unit (GPU, etc.), computer-readable storage device (e.g., main memory, static memory, etc.), or combinations thereof, wherein said elements can communicate with each other via a wired or wireless communication.

Reference is now made to FIG. 2 illustrating a system 150 for decontaminating solids from hydrocarbon compounds and recovering the hydrocarbon compounds, according to some embodiments. According to some embodiments, system 150 comprises: (a) two thermal hydrocarbon removal units (110A, 110B); (b) an outlet line (13); and (c) a cooling unit (14) in solid-fluid communication with the outlet line (13). Also, according to some embodiments, as shown in FIG. 2, each one of the two thermal hydrocarbon removal units (110A, 110B) is in fluid communication with the outlet line 13.

As can be appreciated by the person having ordinary skill in the art, the system 150 is constructed and functions in a similar fashion to the system 100, which is described above, with the distinction that system 100 portrays a specific embodiment directed to a single thermal hydrocarbon removal unit. Thus, many of the elements of system 150 and functions thereof, which are described herein, are constructed, positioned and function as described for the corresponding elements of system 100. Prominent distinction or similarities are depicted below.

According to some embodiments, thermal hydrocarbon removal unit 110A includes feed tank 7, into which can be fed the solids to be treated B1. Feed tank 7 is in solid-fluid communication with the inner space 4 of inner tube 2 of unit 110A, via valve 8 and solids inlet opening 112A. According to some embodiments, during operation of system 150, solids B1 may be transferred into inner space 4 of unit 110A along direction arrow 103. Transportation means 6 of unit 110A is disposed within inner space 4 thereof, and is configured to transport or convey the contaminated solids B1 within the inner tube 2, from the proximity of the first edge 114A of the elongated double tube (i.e., hydrocarbon removal unit) 110A upwards towards the second edge 116A thereof, along the longitudinal axis 101A. According to some embodiments transportation means 6 (e.g., rotating screw 6) is coupled to an actuator 6A configured to generate the rotational movement of the transportation means 6 around the longitudinal axis 101. Seal 5 of unit 110A may be positioned in proximity to the first edge 114 thereof, and configured to prevent solids B1 from entering into, or contacting, actuator 6A.

According to some embodiments, intermediate solids outlet opening 218 is in fluid communication with inner space 4 of hydrocarbon removal unit 110A. Solids B1 which are transported along the length of inner tube 2 may be discharged via intermediate solids outlet opening 218, or simply fall therethrough, into the inner space 4B of the following hydrocarbon removal unit 110B. The function and components of hydrocarbon removal unit 110B may be essentially similar to hydrocarbon removal unit 110A, where intermediate outlet opening 218 fills a corresponding function with respect to hydrocarbon removal unit 110B to that of feed tank 7 and valve 8 with respect to hydrocarbon removal unit 110A, i.e., introduction of solids into the hydrocarbon removal unit. Solids B1, which enter inner space 4B of hydrocarbon removal unit 110B are transported or conveyed within the inner tube 2B thereof, from the proximity of the first edge 114B of hydrocarbon removal unit 110B upwards towards the second edge 116B thereof, along the longitudinal axis 101B. According to some embodiments, inner space 4B of inner tube 2B is in solid-fluid communication with a decontaminated solid tank 12, via solids outlet opening 118 and valve 8A, positioned in proximity to the second edge 116B. When solids are in proximity of the second edge 116B, they fall or are discharged via opening 118 and through valve 8A into decontaminated solid tank 12, as described when the corresponding elements of FIG. 1 are presented herein. Alternatively or additionally, once substantially all hydrocarbon compounds have been removed from solids B1, solids B1 are discharged through valve 8A into a decontaminated solid tank 12.

According to some embodiments, intermediate outlet opening 218 is connected to the edge 116A of hydrocarbon removal unit 110A, and leads the solids into inner space 4B at a location proximate to edge 114B of hydrocarbon removal unit 110B. In other embodiments opening 218 may lead the solids from any particular location along inner space 4 (“discharge point”) into any particular location along inner space 4B of hydrocarbon removal unit 110B (“delivery point”). The discharge and delivery points, respectively, may be determined by a variety of factors, such as the required purity level of the solids, space and engineering limitations, and others.

For example, the discharge point of outlet opening 218 may be at a substantially middle location of hydrocarbon removal unit 110A, such that a first portion of the treated solids is discharged through outlet opening 218, and a second fraction/portion continues to advance along the length of hydrocarbon removal unit 110A. The second fraction/portion may be independently collected upon reaching the edge 116A, e.g., by an outlet opening leading into a solid collection tank (not shown).

This arrangement may be useful when various degrees of solids purity are required. For the sake of illustration, and not to be limited by any theory, a purification achieved by solids being advanced along a single hydrocarbon removal unit will be defined as one degree of purity, and any partial advance along a hydrocarbon removal unit will be defined as a respective partial degree of purity. When, for example, there is a need for solids at 1 degree of purity and solids at 1.5 degrees of purity, outlet opening 218 may be positioned in the middle of hydrocarbon removal unit 110A, and may lead the solids into hydrocarbon removal unit 110B proximately to edge 114B, such that the solids which are discharged through outlet opening 218 undergo 1.5 degrees of purification, and the solids which continue to the edge 116A of hydrocarbon removal unit 110A undergo 1 degree of purification. Depending on the ratio of the more highly purified solids (e.g., 1.5 degree) relative to the less purified solids (e.g., 1 degree), outlet opening 218 may be configured to lead a corresponding percentage of the solids out of hydrocarbon removal unit 110A into hydrocarbon removal unit 110B, allowing the remainder to continue along hydrocarbon removal unit 110A and be collected from edge 116A. The location of the discharge point of outlet opening 218 from inner space 4, and the discharge rate and/or volume thereof, may be adjusted according to need, e.g., by providing a plurality of connection points to inner space 4 along hydrocarbon removal unit 110A, and by altering the diameter of the gateway of outlet opening 218, respectively.

According to some embodiments, at least one outlet line 13 is in fluid communication with each one of the inner spaces (4 and 4B) of hydrocarbon removal units 110A and 110B individually. Due to heating of inner spaces 4 and 4B, volatile hydrocarbon compounds are separated as vapors from solids B1 and flow (or are drawn under vacuum as detailed with respect to system 100) into a corresponding outlet line 13, through at least one respective vapor outlet opening 13A, 13D in the inner tube 2 of each hydrocarbon removal unit 110A, 110B. According to some embodiments, heat is transferred from hot gas flowing through the intermediate space 3 of outer tube 1, which surrounds inner tube 2, via a thermally conducting wall of the inner tube 2, into the inner space 4 thereof and further into solids B1 transported therethrough. According to some embodiments, the intermediate space 3 of outer tube 1 is in fluid communication with a heating device 9. According to some embodiments, heating device 9 is heated by an electric heating system 10A, which provides hot gas, or heats gas contained within heating device 9 or added thereto. The hot gas then flows into the intermediate space 3 of outer tube 1. According to other embodiments, heating device 9 is heated by a fuel source which is steadily burned. According to yet further embodiments, heating device 9 may be heated by a hybrid combination of electric heating and fuel-based heating. Hydrocarbon removal units 110A, 110B may be heated by a shared heating device 9, or may each include, or be in communication with, an independent heating device 9. Each possibility represents a separate embodiment.

According to some embodiments, any one of hydrocarbon removal units 110, 110A and 110B comprises a gas release tube 25 for releasing the hot gas used to heat the corresponding hydrocarbon removal units. According to some embodiments, gas release tube 25 is in fluid communication with intermediate space 3 of outer tube 1, and is configured relieve gas pressure from intermediate space 3. Continuous streaming of heated gas from heating device 9 into intermediate space 3 can cause gas pressure to build up therein, and, when needed, the gas can be expelled through gas release tube 25 thereby lower the gas pressure. Release tube 25 may be configured to allow a predetermined gas-pressure to continuously flow thereout. The predetermined gas-pressure level may be adjustable. Alternatively or additionally, release tube 25 may be configured to expel gas therefrom when subjected to a pressure which is above a predetermined threshold. According to some embodiments, gas release tube 25 comprises an opening, which allows fluid communication between the intermediate space 3 and the external environment of system 100 or 150. According to some embodiments, gas release tube 25 is positioned in the proximity of the second edge 116, 116A or 116B.

As a result from the heating of the inner space 4 of inner tube 2 (via thermal conduction), the temperature therein is heated to a temperature in the range of about 40-900° C., optionally 120-800° C., or optionally 150-600° C. Each possibility represents a different embodiment. In some embodiments, the heated temperature of the inner space 4 may be in a different range for each of the respective hydrocarbon removal units 110A, 110B, inducing evaporation of a different set of volatile hydrocarbon compounds. For example, the temperature in the inner space 4 of the first hydrocarbon removal unit 110A may be in the range of 40-450° C., and the temperature in the inner space 4(B) of the second hydrocarbon removal unit 110B may be in the range of 450-900° C. As a result, when the solids are advanced within hydrocarbon removal unit 110A the volatile hydrocarbon compounds with a boiling point up to 450° C. are cleared from the soil and optionally collected, and when the solids are subsequently advanced within hydrocarbon removal unit 110B the volatile hydrocarbon compounds with a boiling point above 450° C. are cleared from the soil and optionally separately collected. Any other temperature ranges may be applied. The temperatures may also be adjusted within a single hydrocarbon removal unit, according to need.

According to some embodiments, the outlet line 13 is fluidly coupled to at least one condensing or cooling unit 14, wherein outlet line 13 enables the vapors to flow into cooling unit 14. According to further embodiments, cooling unit 14 is configured to cool and/or to condense back into liquid form at least a portion of the hydrocarbon vapors transferred or conveyed thereto. This is elaborated when referring to system 100.

According to some embodiments, cooling unit 14 (e.g., a quencher) comprises at least one water spray system 15 configured to spray water to cool and/or condense at least a portion of the hydrocarbon vapors therein. According to other embodiments, water spray system 15 is configured to wash the hydrocarbon vapors to reduce the quantity of polluting particles therefrom.

A first portion of the hydrocarbon vapors within the cooling unit 14 condenses back into a liquid form, to produce a mixture of water and condensed hydrocarbon vapors as a liquid mixture C1 (e.g., water and oil) disposed at the bottom of the cooling unit 14. Liquid mixture C1 can include a mixture of condensed hydrocarbon vapors and water originating from the water spray system 15 and/or from other sources.

According to some embodiments, a first fraction of the liquid mixture C1 transfers into a separator C2 (optionally due to the gravitational force), which is in fluid communication with the cooling unit 14. According to some embodiments, separator C2 is an oil in water separator, configured to separate water from the first fraction of condensed hydrocarbon vapors of mixture C1. After the separation, water flow out therefrom through water outlet C4, while the condensed hydrocarbon vapors flow via a liquid outlet line 19 and are transferred or conveyed into a liquid tank 20, thus producing a first hydrocarbon liquid product C3. Thus, liquid tank 20 comprises condensed hydrocarbon vapors or the first hydrocarbon liquid product C3 therein (e.g., oil). According to some embodiments, separator C2 is in fluid communication with the liquid tank 20.

According to some embodiments, a second portion of the hydrocarbon vapors within the cooling unit 14 does not condense, and said hydrocarbon vapors are transferred or conveyed via an outlet gas pipe 16A into a vacuum pump 16, and then into an abatement system 17. According to further embodiments, abatement system 17 is a gas-air abatement system (e.g., a scrubber or an oxidizer), which is configured to detoxify the gases transferred therethrough and discharge them safely via a gas outlet pipe 18 into the external environment (e.g., atmosphere). According to some embodiments, cooling unit 14 is in fluid communication with the abatement system 17.

According to some embodiments, vacuum pump 16 is further configured to convey or draw the hydrocarbon vapors, under vacuum, from at least one of the inner spaces (4, 4B) of inner tube (2, 2B) into the outlet line 13. According to some embodiments, vacuum pump 16 is further configured to reduce the pressure within at least one of the inner spaces (4, 4B) of inner tube 2, thus enabling to heat the hot gas conveyed or flowing through the intermediate space 3 of outer tube 1 to lower temperatures (due to the reduced pressure), and still enable to effectively transfer heat to solids B1 disposed within the inner spaces 4, (4B) to achieve the required evaporation therefrom, as disclosed herein above. According to some embodiments, vacuum pump 16 is further configured to reduce air atmosphere within at least one of the hydrocarbon removal units 110A, 110B or to prevent air entry thereto.

According to some embodiments, cooling unit 14 comprises an additional or different cooling apparatus or system disposed therein, which is configured to condense at least a portion of the hydrocarbon vapors therein. According to some embodiments, cooling unit 14 is in solid-fluid communication with at least one of the inner spaces (4, 4B) of inner tube (2, 2B) via the outlet line 13. According to some embodiments, a second fraction of the liquid mixture C1 from the cooling unit 14 is not transferred into separator C2, and instead is transferred or redirected or recirculated back into outlet line 13, thus forming a reflux stream D1 optionally consisting of water-steam, condensed hydrocarbon vapors, or a combination thereof, which is conveyed or flows downward through outlet line 13 back into at least one of the inner spaces (4, 4B) of inner tube 2.

According to some embodiments, the outlet line 13 is in solid-fluid communication via the outlet openings 13A, 13D with the inner spaces (4, 4B) of inner tube 2 of hydrocarbon removal units 110A, 110B, respectively. According to some embodiments, outlet line 13 is extending from the hydrocarbon removal units 110A, 110B, vertically relative to the longitudinal axis 101 or to the horizontal base 102. According to some embodiments, outlet line 13 is extending from the hydrocarbon removal units 110A, 110B, at an outlet line angle selected from 10-90° relative to the longitudinal axis 101 or to the horizontal base 102.

According to some embodiments, outlet line 13 comprises at least two sections: a first section (13B, 13E) which extends from the hydrocarbon removal units 110A, 110B, respectively, towards a line bending, and a second section 13C which extends from the line bending towards the cooling unit 14. According to some embodiments, the second section 13C has a diameter which is smaller than a diameter of the first section 13B and/or 13E by at least 5%. In further such embodiments, the diameter of the second section 13C is smaller than the diameter of the first section 13B by at least 10%, at least 20%, at least 30%, at least 40%, at least 50%, or more. It is contemplated, that the bigger diameter of the first section 13B, 13E combined with the optional cooling of the first section 13B, 13E of outlet line 13, enables at least partial condensation of the vapor flowing therethrough mainly on the wall of first section 13B, 13E and thus at least partially forms at least one of reflux streams D1, D2 which flows downward therethrough and enters into the inner spaces 4, 4B of the inner tubes 2, 2B. Since the second section 13C optionally transfers mainly vapors, it can have a smaller diameter relative to the first section 13B, 13E.

According to some embodiments, reflux stream D1, D2 flows downward into the inner space 4 of inner tube 2, and then downward in the direction of the first edge 114A, 114B thereof. Due to the inclination of the thermal hydrocarbon removal units 110A, 110B, the reflux stream D1, D2 flows downward within the inner spaces 4, 4B of inner tubes 2, 2B (due to the gravitational force).

The condensed hydrocarbon vapors of reflux stream D1, D2 flow downwards along the inner space (4, 4B) of inner tube 2 in the direction of the first edge 114A, 114B thereof, exits inner spaces 4, 4B through liquid outlets 119, 119B in fluid communication therewith, and finally accumulates within liquid containers 22, 22B which are in fluid communication therewith. According to some embodiments, each one of liquid containers 22, 22B comprises condensed hydrocarbon vapors from reflux streams D1, D2, respectively, defined as a second hydrocarbon liquid product D3, D4 (e.g., oil) disposed therein.

It is noted, that any embodiments described in relation to system 100, or specific component thereof, are correspondingly applicable to system 150, unless expressly stated otherwise.

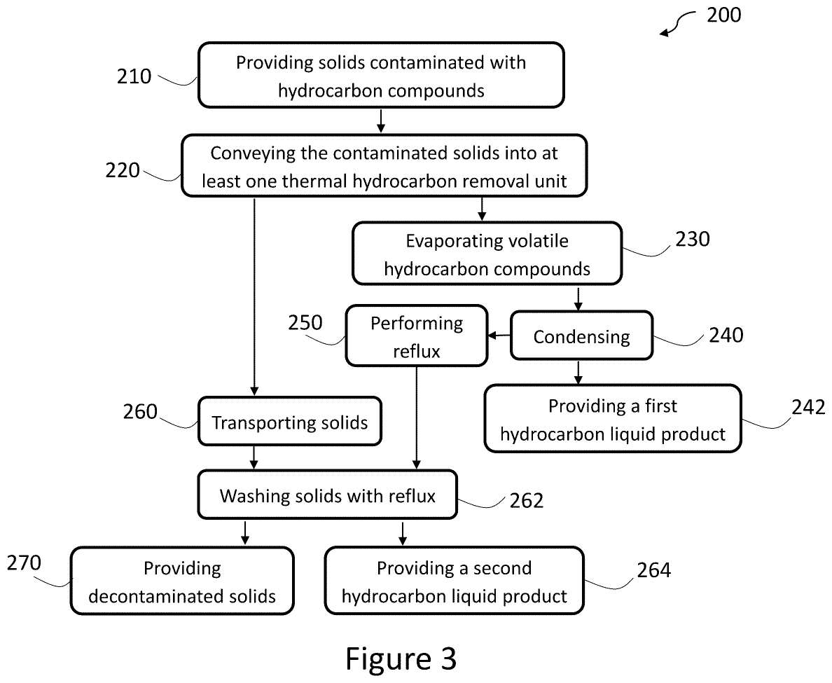

Reference is now made to FIG. 3 showing a method 200 for recovering hydrocarbon compounds from contaminated solids, based on system 100 as disclosed herein above, according to some embodiments. It is to be understood that many of the method 200 steps are elaborated above, when referring to the systems 100 and 150, and are not repeated.

According to some embodiments, method 200 comprises step 210 of providing solids (e.g., soil, particles, granules, etc. Termed herein above ‘solids A’) which are contaminated with hydrocarbon compounds, and specifically with petroleum hydrocarbons, as disclosed herein above. According to some embodiments, step 210 further comprises providing system 100 as disclosed herein above, and introducing or conveying the contaminated soil and/or particles into system 100 via a feed pipe or tank (e.g., feed tank 7) coupled thereto.

According to some embodiments, method 200 further comprises step 220 of providing at least one thermal hydrocarbon removal unit (e.g., thermal hydrocarbon removal unit 110, including any definition or variation thereof as described above) and introducing or conveying the contaminated solids thereto, in order to perform thermal treatment for separation and removal of hydrocarbon compounds therefrom. According to some embodiments, step 220 further comprises indirectly heating the contaminated solids within the thermal hydrocarbon removal unit by a hot gas, wherein the gas is heated to a temperature selected from the range of about 100-1000° C., while simultaneously transporting or conveying the contaminated solids upwards within the thermal hydrocarbon removal unit.

According to some embodiments, method 200 further comprises step 230 of evaporating volatile hydrocarbon compounds from the solids within the thermal hydrocarbon removal unit, due to the heating performed at step 220, thus at least partially decontaminating the solids. The hydrocarbon vapors are conveyed or drawn under vacuum into a condenser or a cooling unit (e.g., cooling unit 14).

According to some embodiments, method 200 further comprises step 240 of condensing a first portion of the hydrocarbon vapors (formed during step 230) within the cooling unit back into liquid, thereby forming condensed hydrocarbon vapors. According to some embodiments, a second portion of the hydrocarbon vapors within the cooling unit does not condense, and is discharged or conveyed via an abatement system into the external environment.

According to some embodiments, method 200 further comprises step 242 of conveying or transferring a first fraction of the condensed hydrocarbon vapors of step 240 into a liquid tank, thereby forming a first hydrocarbon liquid product consisting of condensed hydrocarbon vapors. According to some embodiments, the first hydrocarbon liquid product is conveyed to a fuel inlet of the heating device and/or to a motor powering the transportation means, for serving as a fuel source thereof.

According to some embodiments, method 200 further comprises step 250 of conveying or transferring a second fraction of condensed hydrocarbon vapors of step 240 back into the thermal hydrocarbon removal unit, thereby recirculating a reflux stream which flows downwards into the thermal hydrocarbon removal unit.

According to some embodiments, method 200 further comprises step 260 of transporting or conveying the solids from the proximity of a first edge of the thermal hydrocarbon removal unit upwards towards the proximity of a second edge thereof.

According to some embodiments, method 200 further comprises step 262 of washing the solids transported upwards within the thermal hydrocarbon removal unit during step 260, with the reflux stream of step 250 flowing downwards therein, thus at least partially decontaminating the solids. During the washing of the solids by the reflux stream, at least some of the hydrocarbon contamination is dissolved to be washed away therefrom. As a result, the reflux stream flowing downwards within the thermal hydrocarbon removal unit contains some of the washed and/or dissolved hydrocarbon contamination therein (from the solids).

Once the reflux stream flowing downwards within the thermal hydrocarbon removal unit reaches the first edge 114 thereof, it is discharged into a storage reflux tank. According to some embodiments, method 200 further comprises step 264 of discharging the reflux stream out from the thermal hydrocarbon removal unit, thus providing a second hydrocarbon liquid product consisting of the reflux stream. According to some embodiments, the second hydrocarbon liquid product is conveyed to a fuel inlet of the heating device and/or to a motor powering the transportation means, for serving as a fuel source thereof.

Once substantially all hydrocarbon compounds (i.e., the contamination) have been removed from the solids, as a result of steps 230 and 262, the decontaminated soil and/or small solids are discharged into a decontaminated solid tank. According to some embodiments, method 200 further comprises step 270 of discharging the decontaminated solids out from the thermal hydrocarbon removal unit, following the decontamination performed during steps 230 and 262, thus providing a decontaminated solid product (soil and/or particles).

As used herein, the term “plurality” means two or more.

As used herein, the term “about”, when referring to a measurable value such as an amount, a temporal duration, and the like, is meant to encompass variations of +/−10%, more preferably +/−5%, even more preferably +/−1%, and still more preferably +/−0.5% from the specified value, as such variations are appropriate to perform the disclosed devices and/or methods.

The word “optionally” is used herein to mean “is provided in some embodiments and not provided in other embodiments”. Any particular embodiment of the invention may include a plurality of “optional” features except insofar as such features conflict.

The terms “comprises”, “comprising”, “includes”, “including”, “having” and their conjugates mean: “including but not limited to”.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. No feature described in the context of an embodiment is to be considered an essential feature of that embodiment, unless explicitly specified as such.

Although the invention is described in conjunction with specific embodiments thereof, it is evident that numerous alternatives, modifications and variations that are apparent to those skilled in the art may exist. It is to be understood that the invention is not necessarily limited in its application to the details of construction and the arrangement of the components and/or methods set forth herein. Other embodiments may be practiced, and an embodiment may be carried out in various ways. Accordingly, the invention embraces all such alternatives, modifications and variations that fall within the scope of the appended claims.

1-50. (canceled)

51. A system for decontaminating contaminated solids from hydrocarbon compounds, the system comprising:
at least one thermal hydrocarbon removal unit, which extends from a first edge to a second edge, and comprises:
an elongated inner tube, which defines an inner space therein, the inner tube comprising
a solids inlet opening proximal to the first edge;
a solids outlet opening proximal to the second edge; and
a vapor outlet opening positioned longitudinally between the first edge and the second edge; and
a transportation means, disposed within the inner space of the elongated inner tube, and configured to transport solids in the direction from the first edge towards the second edge of the thermal hydrocarbon removal unit;
at least one heating device configured to apply indirect heat to the inner space of the elongated inner tube; and
a cooling unit connected to the vapor outlet opening of the inner tube, through an outlet line, wherein the outlet line is oriented so that the cooling unit is positioned above the vapor outlet opening.

52. The system of claim 51, wherein the at least one thermal hydrocarbon removal unit further comprises an elongated outer tube extending circumferentially around the inner tube and is in thermal communication therewith, wherein the at least one heating device is configured to apply heat to the elongated outer tube, to indirectly heat the inner space of the elongated inner tube.

53. The system of claim 52, wherein the at least one thermal hydrocarbon removal unit is in the form of a double tube, which defines an intermediate space between the elongated inner tube and the elongated outer tube.

54. The system of claim 53, wherein the at least one heating device is configured to produce a hot gas and to deliver the hot gas to the intermediate space between the elongated inner tube and the elongated outer tube.

55. The system of claim 54, wherein the at least one heating device comprises a burner, and is coupled to a fuel supply.

56. The system of claim 51, wherein the at least one thermal hydrocarbon removal unit is inclined, so that the second edge thereof is at a higher position relative to the first edge thereof.

57. The system of claim 51, wherein the at least one thermal hydrocarbon removal unit further comprises a liquid outlet longitudinally positioned between the first edge of the thermal hydrocarbon removal unit and the vapor outlet opening.

58. The system of claim 57, wherein the liquid outlet is connected to a liquid container.

59. The system of claim 51, wherein the outlet line is in the form of a bent tube, and comprises:
a first section, which extends from the vapor outlet opening towards a line bending; and
a second section which extends from the line bending towards the cooling unit;
wherein the second section has a diameter which is smaller than a diameter of the first section.

60. A system for decontaminating contaminated solids from hydrocarbon compounds, the system comprising:
(a) at least one thermal hydrocarbon removal unit comprising transportation means disposed therein, and a solid inlet, a solid outlet, a liquid outlet, and a vapor outlet coupled thereto, wherein the at least one thermal hydrocarbon removal unit is configured to apply indirect heat to the contaminated solids, while said transportation means is configured to convey the contaminated solids therethrough, and wherein the indirect heat generates volatile hydrocarbon vapors within the at least one thermal hydrocarbon removal unit;
(b) at least one outlet line in solid-fluid communication with the vapor outlet of the thermal hydrocarbon removal unit, wherein said at least one outlet line enables hydrocarbon vapors flow therethrough; and
(c) at least one cooling unit in solid-fluid communication with the at least one outlet line, configured to condense a first portion of the hydrocarbon vapors entering thereto, wherein a first fraction of the condensed hydrocarbon vapors is released out therefrom to produce a first hydrocarbon liquid product,
wherein a second fraction of the condensed hydrocarbon vapors is recirculated back into the outlet line to form a reflux stream flowing back into the thermal hydrocarbon removal unit, and
wherein a second portion of the hydrocarbon vapors which does not condense is released as vapors to the external environment,
wherein the reflux stream flows downwards within the thermal hydrocarbon removal unit and dissolves at least partially the contamination from the solids conveyed therethrough, thus enabling to produce and release decontaminated solids via the solid outlet of the thermal hydrocarbon removal unit, and to produce a second hydrocarbon liquid product via the liquid outlet thereof.

61. The system of claim 60, further comprising a feed tank or pipe configured to introduce or to convey the contaminated solids into the thermal hydrocarbon removal unit.

62. The system of claim 61, further comprising a valve in solid-fluid communication with the feed tank or pipe, configured to regulate a release rate of the solids therethrough and into the at least one thermal hydrocarbon removal unit via the solid inlet.

63. The system of claim 60, wherein the outlet line is in the form of a bent tube, and comprises:
a first section, which extends from the vapor outlet opening towards a line bending; and
a second section which extends from the line bending towards the cooling unit;
wherein the second section has a diameter which is smaller than a diameter of the first section.

64. A method for recovering hydrocarbon compounds from contaminated solids, the method comprising:
(a) providing contaminated solids into a system comprising at least one thermal hydrocarbon removal unit which is in solid-fluid communication with at least one cooling unit via at least one outlet line;
(b) conveying the contaminated solids through the at least one thermal hydrocarbon removal unit;
(c) evaporating volatile hydrocarbon compounds from the solids within the thermal hydrocarbon removal unit into the cooling unit, thus at least partially decontaminating the solids;
(d) condensing a first portion of the hydrocarbon vapors within the cooling unit;
(e) conveying a first fraction of the condensed hydrocarbon vapors of step (d) into a liquid tank, thereby forming a first hydrocarbon liquid product therein;
(f) conveying a second fraction of condensed hydrocarbon vapors of step (d) back into the thermal hydrocarbon removal unit, thereby recirculating a reflux stream which flows downwards into the thermal hydrocarbon removal unit;
(g) transporting the solids from a first edge of the thermal hydrocarbon removal unit upwards towards a second edge thereof while washing the solids with the reflux stream of step (f) flowing downwards therein, thus at least partially decontaminating the solids;
(h) discharging the reflux stream out from the thermal hydrocarbon removal unit following step (g), thus providing a second hydrocarbon liquid product; and
(i) discharging the decontaminated solids out from the thermal hydrocarbon removal unit, following the decontamination performed during steps (c) and (g), thus providing a decontaminated solid product.

65. The method according to claim 64, wherein step (b) further comprises indirectly heating the contaminated solids within the thermal hydrocarbon removal unit by a hot gas, wherein the gas is heated to a temperature selected from the range of about 100-1000° C., while simultaneously transporting or conveying the solids upwards within said inner space within the thermal hydrocarbon removal unit.

66. The method according to claim 64, wherein the thermal hydrocarbon removal unit is an inclined elongated double tube, wherein the contaminated solids are conveyed through an inner tube using a rotating screw coupled to at least one actuator, while hot gas is conveyed through a space positioned between an outer tube and the inner tube.

67. The method according to claim 64, wherein step (d) further comprises discharging a second portion of the hydrocarbon vapors which does not condense into the external environment, optionally via an abatement system.

68. The method according to claim 64, wherein the system in step (a) comprises a plurality of thermal hydrocarbon removal units connected in a series and in solid-fluid communication with each other, wherein each thermal hydrocarbon removal unit is in solid-fluid communication with at least one cooling unit via at least one corresponding outlet line, and wherein step (b) comprises conveying the contaminated solids through the plurality of thermal hydrocarbon removal units.

69. The method according to claim 68, wherein step (c) comprises heating each thermal hydrocarbon removal unit to a different temperature, and evaporating volatile hydrocarbon compounds from the solids within each thermal hydrocarbon removal unit into each corresponding cooling unit, thus enabling to produce a first hydrocarbon liquid product in step (e) and a second hydrocarbon liquid product in step (h) from each thermal hydrocarbon removal unit.

70. The method according to claim 64, wherein the outlet line is in the form of a bent tube, and comprises:
a first section, which extends from the vapor outlet opening towards a line bending; and
a second section which extends from the line bending towards the cooling unit;
wherein the second section has a diameter which is smaller than a diameter of the first section.
